(19) United States
(12) Patent Application Publication
(10) Pub. No.: US 2017/0074393 A1
(43) Pub. Date: Mar. 16, 2017

(54) All Clutch Sequential (ACS)

(71) Applicant: Nentor Marku, Tirana (AL)

(72) Inventor: Nentor Marku, Tirana (AL)

(21) Appl. No.: 14/851,730

(22) Filed: Sep. 11, 2015

(51) Int. Cl. F16H 61/02; F16H 37/02; F16D 21/00

(52) U.S. Cl. CPC F16H 61/0204; F16D 21/00; F16H 61/0265; F16H 37/02

(57) ABSTRACT

A sequential clutch gear system is disclosed which functions to provide one separate shaft for each gear which is activated by its own separate clutch. The system shift any gear at any time (therefore not necessarily in the sequential order) which provides automatic and manual transmission both also, it eliminate the use of clutch manually and gear freely at any number. The transmission system further includes a sequential gear box arrangement which comprises: an engine shaft which transmits engine rotation to transmission entrance; an drive shaft engaged via at least one belt, at least one chain, one or more planetary gears including at least one reverse gear; one or more clutch; on other side of said clutch one or more shaft with said gear connected to the said drive shaft; said drive shaft connected to the tyres.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

This invention relates to sequential clutch gear transmissions with a shaft and plurality of gears with clutch pairs comprising free gears that can be brought to a rotation-locked engagement with a shaft.

(2) Background of the Invention

Conventional car transmission systems can be generally divided into two groups: manually operated transmission systems, and automatically operated transmission systems.

The manually operated transmission systems employ gear sets with different gear ratios for transmitting power, and have better transmission efficiency. However, when driving a car with a manually operated transmission system, a driver must frequently step and release the clutch pedal, and then shift the gear lever according to the running speed and road condition to change the transmission ratios and transmission torque. Such procedures consume the driver's physical and mental energy. The shifting movement may keep the driver from concentrating on the driving, and thus cause an accident; especially when the traffic conditions are complex or the driver is unskilled.

The automatically operated transmission can eliminate the troublesome procedures of stepping and releasing the clutch pedal and shifting the gear lever. However, because the automatically operated transmission employs a fluid as the medium for transmitting the power of the engine and a power transmission delay phenomenon occurs at two ends of the fluid torque changing device, the efficiency is not desirable. Therefore, the automatic transmission car is more fuel consuming than the manual transmission car, and the acceleration/deceleration of the automatic transmission car is more obtuse than the manual transmission car. In addition, the braking frequency of the automatic transmission car is higher, and the wear of the brake thereof is greater.

Most vehicles are equipped with shift mechanisms that allow the driver to select gear ratios randomly. In racing cars and motorcycles, it is desirable to select gear ratios sequentially in increasing or decreasing order. Selecting a gear ratio out of order can cause a crash or wreck of the vehicle. The invention disclosed herein is a sequential gear shifting mechanism.

Generally, automatic transmissions include gear elements for defining several different forward speed or gear ratios between the input and the output shaft of the transmission. The input shaft is linked to the engine, and the output shaft is indirectly linked to the wheels. The shifting between speed ratios is facilitated by a number of clutches that can be applied and released by hydraulic pressure to create an array of speed ratios between the input and output shaft. Typically, two clutches are applied to create a forward speed ratio. When a change from one speed ratio to another is desired, one of the applied clutches releases as another clutch applies to create a speed ratio different from the previous speed ratio. The clutches are attached to various gear sets, when certain clutches are applied torque is delivered to the proper gear sets to produce the desired ratio.

A transmission has a number of gears, typically, first, second, third, and fourth gear. Typically, each gear has an associated speed ratio. The speed ratio created by the application of fluid operated clutches is typically defined as Ni/No, where Ni is the input shaft speed, and No is the output shaft speed. The lower the gear, the higher the speed ratio. Conversely, the higher the gear, the lower the speed ratio. Accordingly, a shift from a given speed ratio to a lower speed ratio is termed up-shifting, while a shift from a given speed ratio to a higher speed ratio is termed downshifting. Typically, an automatic transmission only up-shifts to adjacent gears, while downshifting may occur to non-adjacent gears to accommodate certain driving situations.

Another difficulty with electronically controlled, motor driven transmission systems is that such systems typically perform poorly when detecting and responding to interference between the gear dogs during shifting. Commonly known as gear jam, the problem occurs when the leading edge of a gear dog belonging to a sliding gear is brought against the leading edge of the gear dog belonging to the corresponding free spinning gear. Under these conditions, the gears may not fully engage or may resist engaging, and the shift attempt will fail. Many modern transmissions incorporate a synchronizer mechanism, commonly known as a synchromesh device, to enable gear engagement. However, these devices add to the size, weight, and cost of the transmission. In the absence of a synchromesh device, if the control system does not sense such interference conditions, it will continue to drive the motor, generating excessive strain on the elements of the system. Under those circumstances, the transmission, the control motor, or both may be damaged. Since a shift of a sequential transmission may occur in a short period of time (e.g. less than one hundredth of a second), any control system would have to be equipped with sensors that detect interference conditions quickly and accurately.

There is a need for a semi-automatic or automatic sequential shift system that detects the in-gear position of the selector shaft and calibrates the controller to adjust for short term changes in temperature and long term changes due to wear and tear. There is a need for control systems for motor controlled sequential transmissions that can prevent gear jams and accurately react to permit gear engagement without risking damage to the engine.

The art of shifting a transmission has been the grounds of many innovations over the years. The precise speed ratios utilized, as well as the shifting sequence, is crucial in developing a drivetrain that is smooth and efficient. There is a continual need to develop drivetrains that are more efficient, shift more smoothly, minimize engine noise, and increase performance. Developing unique shifting schemes as well unique speed ratio configurations can help in meeting this continual need for drivetrain development.

### SUMMARY OF THE INVENTION

The present invention provides a sequential gear and a control system for permitting automatic shifting of any gear at any time (therefore, not necessarily in sequential order).

It is yet another objective of the present invention to provide a sequential gear and a control system that has one shaft that is powered by the engine. In the preferred embodiment, the shaft holds the gear from 1^{st} to number required.

In addition to this, the present sequential gear and a control system are comprised of a main shaft that has a number of gears. This is connected to a sprocket (spur gear) of the same size. Also, each shaft has its own clutch, which is engaged by an electrical solenoid valve, pneumatic valve, or hydraulic valve.

Accordingly, it is a specific objective of this invention to provide a sequential gear control system for selecting one of a plurality of gear selection control programs for altering the sequence of operation of the transmission gear from continuous sequential selection of all of the gear ratios to only a portion of the gear ratios. Therefore, this system eliminates pressing the clutch manually.

Also, it will be noted that, due to the present design, all shifting is achieved with continuously constant gear mesh, thereby effecting substantially constant accelerations and decelerations, producing no sudden shocks while changing speeds, and reducing wear and tear.

It is yet objective of the present sequential gear control system to provide both automatic transmission and manual transmission. taken in a limiting sense, and the scope of the present invention is defined by the appended claims and their equivalents.

With reference to FIG. 1, a sequential clutch gear system of the present invention is comprised of one separate shaft 1 for each gear, which is activated by its own separate clutch 2. Technically, this design provides the ability to shift any gear at any time (therefore, not necessarily in the sequential order) and having both automatic transmission and manual transmission. Also, this system, when installed in the manual transmission, will eliminate the use of clutch manually, and allow gear switches freely. For example, the gears may switch from the 1^{st} 3 to the 3^{rd} 4 or to the 5^{th} 5 gear, and from the 5^{th} gear to the 4^{th} 6 or 2^{nd} 7 immediately. Similarly, in case of automatic transmission, there is the traditional S-tronic gear, which will engage one by one automatically with the help of preferred gear system 8.

According to the preferred embodiment, the present sequential clutch gear system is comprised of a main shaft that is powered by the engine 9 in such a way that engine spins only the shaft of the clutch. This shaft holds the gear from 1^{st} to whatever number is required (not necessarily in sequential order). Each shaft is connected to each gear with a sprocket (spur gear), which are of same size.

According to the preferred embodiment of the present sequential clutch gear system, each shaft has its own clutch that is engaged by an electrical solenoid valve, pneumatic valve, or hydraulic valve. These shafts continue past the clutch and connect with the drive shaft 10, which in turn is connected to spur gears, chain belt 11 and planetary gears including the reverse gear 12 as well.

According to the preferred embodiment of the present sequential clutch gear system, all gears are engaged at all times, which reduces wear and tear. Additionally, the above-discussed system is comprised of one shaft known as a drive engine, which holds all gears, and one shaft per gear separated by its clutch. The shaft ends are connected to the drive shaft, which provides both automatic transmission and manual transmission. Automatic and manual transmission is all in one, and is the same transmission. However, this system eliminates the need to press the clutch manually.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic view of a shaft with sequential clutch attached with multiple gears according to the principles of the present invention.

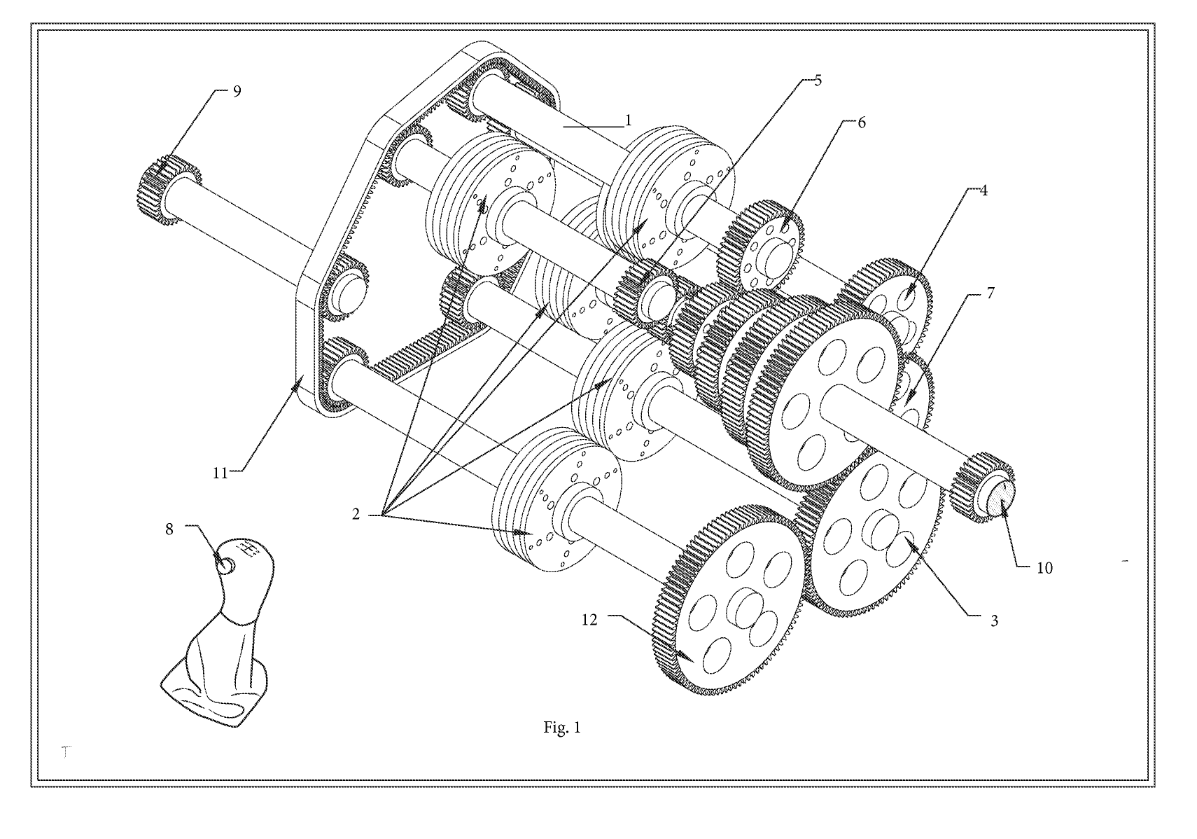

### DETAILED DESCRIPTION OF THE INVENTION

In the following detailed description, reference is made to the accompanying drawings that form a part hereof, and in which is shown, by way of illustration, specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced, are not to be construed as critical, required, or essential features of any or all of the embodiments.

While the present invention has been described with reference to particular embodiments, it should be understood that the embodiments are illustrative, and that the scope of the invention is not limited to these embodiments. Many variations, modifications, additions, and improvements to the embodiments described above are possible. It is contemplated that these variations, modifications, additions, and improvements fall within the scope of the invention.

I claim:

1. A sequential clutch gear transmission system comprised of:
an engine shaft;
a drive shaft adapted for connection to the other shaft and having an output gear fixed thereto;
a plurality of planetary gears;
a plurality of clutches per gear;
a reverse gear; and
at least one chain belt.

2. The sequential clutch gear transmission system of claim 1, wherein said gears are engaged with each other at all times.

3. The sequential clutch gear transmission system of claiml, wherein said clutch is engaged by an electrical solenoid valve, pneumatic valve, and/or hydraulic valve.

4. The sequential clutch gear transmission system of claim 1, wherein each said shaft arranged per gear.

5. The sequential clutch gear transmission system of claiml, wherein said shaft is activated by its own separate clutch.

6. The sequential clutch gear transmission system of claiml, wherein said shaft end is connected to said drive shaft.

7. The sequential clutch gear transmission system of claiml, wherein said transmission is both automatic and manual.

8. A sequential gear box arrangement comprised of:
an engine shaft that transmits engine rotation to transmission entrance;
a drive shaft engaged via at least one belt, at least one chain, one or more planetary gears including at least one reverse gear; one or more clutch;
on other side of said clutch one or more shaft with said gear connected to said drive shaft; and
said drive shaft connected to the tyres.

9. The sequential gear box arrangement of claim 1, wherein said gears are connected to each said shaft and said clutch.
